(19) United States
(12) Patent Application Publication
(10) Pub. No.: US 2023/0039182 A1
(43) Pub. Date: Feb. 9, 2023

(54) METHOD, APPARATUS, COMPUTER DEVICE, STORAGE MEDIUM, AND PROGRAM PRODUCT FOR PROCESSING DATA

(71) Applicant: Tencent Technology (Shenzhen) Company Ltd., Shenzhen (CN)

(72) Inventors: Yong CHENG, Shenzhen (CN); Yangyu Tao, Shenzhen (CN)

(21) Appl. No.: 17/971,488

(22) Filed: Oct. 21, 2022

Related U.S. Application Data
(63) Continuation of application No. PCT/CN2021/142467, filed on Dec. 29, 2021.

(30) Foreign Application Priority Data
Jan. 5, 2021 (CN) 202110005822.9

(51) Int. Cl. G06N 20/20; G06F 21/60

(52) U.S. Cl. CPC G06N 20/20; G06F 21/602

(57) ABSTRACT

A method, an apparatus, a computer device, a storage medium, and a program product for processing data are provided, which belong to the technical field of artificial intelligence. The method includes: acquiring model training information transmitted by each of at least two edge node devices, the model training information being transmitted in a form of plaintext, and being obtained by the edge node device by training sub-models through differential privacy; acquiring, based on the model training information transmitted by each of the at least two edge node devices, the sub-models trained by each of the at least two edge node devices; and performing, based on a target model ensemble policy, model ensemble on the sub-models trained by the at least two edge node devices, to obtain a global model. This solution expands the manner of model ensemble while ensuring the data security, thereby improving the model ensemble effect.

### CROSS-REFERENCE TO RELATED APPLICATIONS

This application is a continuation application of PCT Patent Application No. PCT/CN2021/142467, entitled “DATA PROCESSING METHOD AND APPARATUS, AND COMPUTER DEVICE, STORAGE MEDIUM AND PROGRAM PRODUCT” filed on Dec. 29, 2021, which claims priority to Chinese Patent Application No. 202110005822.9, filed with the State Intellectual Property Office of the People's Republic of China on Jan. 5, 2021, and entitled “DISTRIBUTED DATA PROCESSING METHOD AND APPARATUS, COMPUTER DEVICE, AND STORAGE MEDIUM”, all of which are incorporated herein by reference in their entirety.

### FIELD OF THE TECHNOLOGY

Embodiments of this application relate to the technical field of artificial intelligence, and in particular, to a method, an apparatus, a computer device, a storage medium, and a program product for processing data.

### BACKGROUND OF THE DISCLOSURE

In response to the continuous development of artificial intelligence and the increasingly high demand for user data security, the application of machine learning model training based on a distributed system is becoming wider.

Federated learning is a machine learning method for the distributed system based on the cloud technology. A federated learning architecture includes a central node device and a plurality of edge node devices, and each edge node device stores respective training data locally. Federated learning (also known as collaborative learning) is a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed. Federated learning enables multiple actors to build a common, robust machine learning model without sharing data, thus allowing to address critical issues such as data privacy, data security, data access rights and access to heterogeneous data. Federated learning includes horizontal federated learning (HFL). In the HFL, respective model gradients are trained according to local training data in a plurality of edge node devices, each model gradient is encrypted and then transmitted to a central node device, the central node device aggregates the encrypted model gradients, and aggregates the encrypted model gradients, and transmits the aggregated encrypted model gradients to each edge node device, and each edge node device may decrypt the acquired aggregated and encrypted model gradients to generate aggregated model gradients, and may update a model according to the aggregated model gradients.

In the above technical solution, for the security of the training data, the model gradient is required to be encrypted. Correspondingly, the central node device uses a secure aggregation algorithm for model ensemble, which limits the manner of model ensemble.

### SUMMARY

Embodiments of this application provide a method, an apparatus, a computer device, a storage medium, and a program product for processing data, which can expand the manner of model ensemble and improve the model ensemble effect. The technical solutions are as follows:

An aspect provides a data processing method, performed by a central node device in a distributed system, the method including:

acquiring model training information transmitted by each of at least two edge node devices of the distributed system, the model training information being transmitted in a form of plaintext, and being obtained by the edge node device by training sub-models through differential privacy;

acquiring, based on the model training information transmitted by each of the at least two edge node devices, the sub-models trained by each of the at least two edge node devices; and

performing, based on a target model ensemble policy, model ensemble on the sub-models trained by the at least two edge node devices, to obtain a global model, the target model ensemble policy being a model ensemble policy other than a cryptography-based security model fusion policy.

An aspect provides a data processing method, performed by edge node devices in a distributed system, the method including:

training a sub-model through differential privacy, and generating model training information;

transmitting the model training information to a central node device of the distributed system in a form of plaintext;

receiving a global model transmitted by the central node device, the global model being obtained by the central node device by performing model ensemble on the sub-models trained by the at least two edge node devices based on a target model ensemble policy, the trained sub-models being models acquired by the central node device based on the model training information, and the target model ensemble policy being a model ensemble policy other than a cryptography-based security model fusion policy.

Another aspect provides a data processing apparatus, applicable to a central node device in a distributed system, the apparatus including:

a training information acquisition module, configured to acquire model training information transmitted by each of at least two edge node devices of the distributed system, the model training information being transmitted in a form of plaintext, and being obtained by the edge node device by training sub-models through differential privacy;

a sub-model acquisition module, configured to acquire, based on the model training information transmitted by each of the at least two edge node devices, the sub-models trained by each of the at least two edge node devices; and

a model ensemble module, configured to perform, based on a target model ensemble policy, model ensemble on the sub-models trained by the at least two edge node devices, to obtain a global model, the target model ensemble policy being a model ensemble policy other than a cryptography-based security model fusion policy.

In one implementation, in response to the target model ensemble policy including a first model ensemble policy,

the model ensemble module includes:

a weight acquisition submodule, configured to acquire, based on the first model ensemble policy, ensemble weights of the sub-models trained by the at least two edge node devices, the ensemble weights being used for indicating impact of output values of the sub-models on an output value of the global model;

a model set generation submodule, configured to acquire at least one sub-model from the sub-models trained by the at least two edge node devices, to generate at least one ensemble model set, the ensemble model set being a set of sub-models for ensembling into a global model; and

a first model acquisition submodule, configured to perform weighted averaging on the sub-models in the at least one ensemble model set based on the ensemble weights to obtain the at least one global model.

In one implementation, the weight acquisition submodule includes

a weight acquisition unit, configured to acquire, based on a weight impact parameter of each of the at least two edge node devices, the ensemble weights of the sub-models trained by the at least two edge node devices,

the weight impact parameter including at least one of reliability of the edge node device or a data amount of a first training data set in the edge node device.

In one implementation, in response to the target model ensemble policy including a second model ensemble policy, the central node device includes a second training data set, the second training data set being a data set stored in the central node device, and including feature data and label data; and

the model ensemble module includes:

a first initial model acquisition submodule, configured to acquire a first initial global model based on the second model ensemble policy;

a first output acquisition submodule, configured to input the feature data in the second training data set to the sub-models trained by the at least two edge node devices, to obtain at least two pieces of first output data;

a first model parameter update submodule, configured to input the first output data to the first initial global model; and

a second model acquisition submodule, configured to update a model parameter in the first initial global model based on the label data in the second training data set and an output result of the first initial global model, to obtain the global model.

In one implementation, in response to the target model ensemble policy including a third model ensemble policy, the central node device includes a second training data set, the second training data set being a data set stored in the central node device, and including feature data and label data; and

the model ensemble module includes:

a second initial model acquisition submodule, configured to acquire a second initial global model based on the third model ensemble policy;

a first output acquisition submodule, configured to input the feature data in the second training data set to the sub-models trained by the at least two edge node devices, to obtain at least two pieces of first output data;

a second output acquisition submodule, configured to input the first output data and the feature data in the second training data set to the second initial global model to obtain second output data; and

a second model parameter update submodule, configured to update a model parameter in the second initial global model based on the second output data and the label data in the second training data set, to obtain the global model.

In one implementation, in response to the target model ensemble policy including a fourth model ensemble policy, the central node device includes a second training data set, the second training data set being a data set stored in the central node device, and including feature data and label data; and

the model ensemble module includes:

a third initial model acquisition submodule, configured to acquire a third initial global model based on the fourth model ensemble policy, the third initial global model being a classification model;

a first output acquisition submodule, configured to input the feature data in the second training data set to the sub-models trained by the at least two edge node devices, to obtain at least two pieces of first output data;

a result acquisition submodule, configured to collect statistics on classification results of the first output data in response to the first output data being classification result data, to obtain a statistical result corresponding to each of the classification results; and

a third model parameter updating submodule, configured to update a model parameter in the third initial global model based on the statistical result and the label data, to obtain the global model.

In one implementation, in response to the target model ensemble policy including a fifth model ensemble policy,

the model ensemble module includes:

a functional layer acquisition submodule, configured to acquire a functional layer of at least one sub-model from the sub-models corresponding to the edge node devices based on the fifth model ensemble policy, the functional layer being configured to indicate a partial model structure that implements a specified functional operation; and

a fifth model parameter acquisition submodule, configured to acquire a model including at least two functional layers as the global model in response to the model composed of the at least two functional layers having a complete model structure.

In one implementation, a same differential privacy algorithm is used during the training performed by the at least two edge node devices on the respective sub-models;

or

different differential privacy algorithms are used during the training performed by the at least two edge node devices on the respective sub-models.

In one implementation, the at least two first training data sets stored in the at least two edge node devices conform to horizontal federated learning (HFL) data distribution.

In one implementation, model structures of the sub-models trained by the at least two edge node devices are different.

Still another aspect provides a data processing apparatus, applicable to edge node devices in a distributed system, the distributed system including a central node device and the at least two edge node devices, the apparatus including:

an information generation module, configured to train sub-models through differential privacy, and generate model training information;

an information transmission module, configured to transmit the model training information to the central node device in a form of plaintext; and

a model receiving module, configured to receive a global model transmitted by the central node device, the global model being obtained by the central node device by performing model ensemble on the sub-models trained by the at least two edge node devices based on a target model ensemble policy, the trained sub-models being models acquired by the central node device based on the model training information, and the target model ensemble policy being a model ensemble policy other than a cryptography-based security model fusion policy.

Still another aspect provides a computer device acting as a central device or edge device of a distributed system, including a processor and a memory, the memory storing at least one instruction, at least one program, a code set, or an instruction set, the at least one instruction, the at least one program, the code set, or the instruction set being loaded and executed by the processor and causing the computer device to implement the data processing method described above.

Still another aspect provides a non-transitory computer-readable storage medium, storing at least one instruction, at least one program, a code set, or an instruction set, the at least one instruction, the at least one program, the code set, or the instruction set being loaded and executed by a processor of a computer device acting as a central device or edge device of a distributed system and causing the computer device to implement the data processing method described above.

Still another aspect provides a computer program product or a computer program, including computer instructions, the computer instructions being stored in a computer-readable storage medium. A processor of a computer device reads the computer instructions from the computer-readable storage medium, and executes the computer instructions, to cause the computer device to perform the data processing method described above.

The technical solutions provided in this application may include the following beneficial effects:

In the distributed system, each of the at least two edge node devices trains the sub-models through differential privacy, and then transmits the model training information obtained by training the sub-models to the central node device in the form of plaintext, and the central node device acquires, through the received model training information, the sub-models trained by each of the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble effect.

It is to be understood that the foregoing general descriptions and the following detailed descriptions are merely for illustration and explanation purposes and are not intended to limit this application.

### BRIEF DESCRIPTION OF THE DRAWINGS

Accompanying drawings herein are incorporated into and constitute a part of this specification, show embodiments that conform to this application, and are used together with this specification to describe the principle of this application.

FIG. 1 is a schematic structural diagram of a distributed system according to an exemplary embodiment.

FIG. 2 is a schematic structural diagram of a distributed system disposed based on a federated learning framework according to an exemplary embodiment.

FIG. 3 is a schematic diagram of horizontal federated learning (HFL) data distribution in the embodiment shown in FIG. 2.

FIG. 4 is a schematic flowchart of a data processing method according to an exemplary embodiment.

FIG. 5 is a schematic flowchart of a data processing method according to an exemplary embodiment.

FIG. 6 is a flowchart of a data processing method according to an exemplary embodiment.

FIG. 7 is a schematic diagram of federated stacking and ensemble learning in the embodiment shown in FIG. 6.

FIG. 8 is a schematic diagram of federated knowledge distillation learning in the embodiment shown in FIG. 6.

FIG. 9 is a schematic framework diagram of a data processing method based on a distributed system according to an exemplary embodiment.

FIG. 10 is a structural block diagram of a data processing apparatus according to an exemplary embodiment.

FIG. 11 is a structural block diagram of a data processing apparatus according to an exemplary embodiment.

FIG. 12 is a schematic structural diagram of a computer device according to an exemplary embodiment.

### DESCRIPTION OF EMBODIMENTS

Exemplary embodiments are described in detail herein, and examples thereof are shown in the accompanying drawings. When the following descriptions are made with reference to the accompanying drawings, unless otherwise indicated, the same numbers in different accompanying drawings represent the same or similar elements. The following implementations described in the following exemplary embodiments do not represent all implementations that are consistent with this application. Instead, they are merely examples of the apparatus and method according to some aspects of this application as recited in the appended claims.

It is to be understood that “several” refers to one or more, and “plurality” refers to two or more in this specification. And/or describes an association relationship for describing associated objects and represents that three relationships may exist. For example, A and/or B may represent the following three cases: only A exists, both A and B exist, and only B exists. The character “/” generally indicates an “or” relationship between the associated objects.

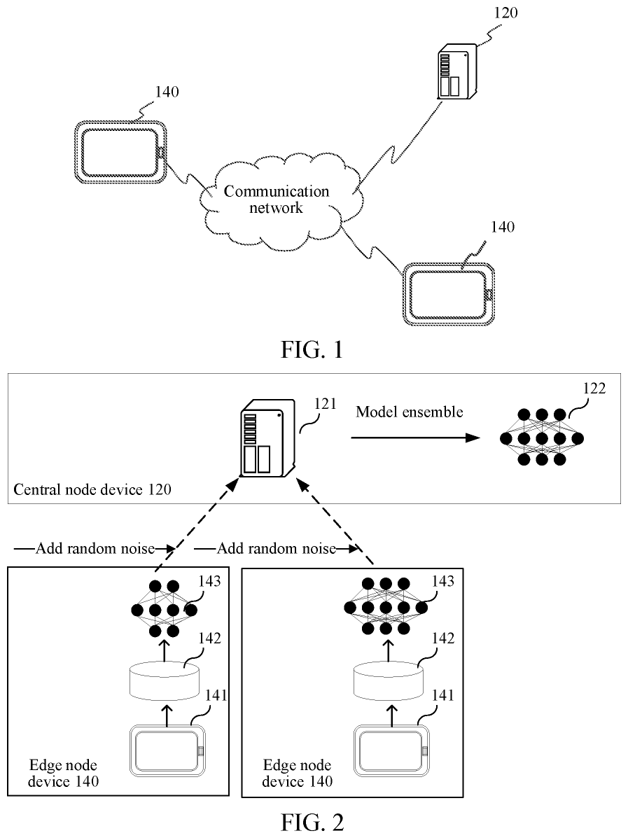

FIG. 1 is a schematic structural diagram of a distributed system according to an exemplary embodiment. The system includes a central node device 120 and at least two edge node devices 140. Each of the at least two edge node devices 140 constructs at least one sub-model, and performs model training on the sub-model through a locally stored training data set. During the training, random noise may be added to data during the training through a differential privacy mechanism. Model training data corresponding to each trained sub-model may be directly transmitted to the central node device 120 in a form of plaintext. The central node device 120 performs model ensemble on the trained sub-models through the model training data and a federated ensemble learning algorithm to generate at least one global model.

The central node device 120 may be a server, and in some scenarios, the central node device may be referred to as a central server. The server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The edge node device 140 may be a terminal, and the terminal may be a smartphone, a tablet computer, a notebook computer, a desktop computer, a smart speaker, a smartwatch, or the like, but is not limited thereto. The central node device and the edge node device may be directly or indirectly connected through wired or wireless communication, which is not limited in this application.

In some embodiments, the system may further include a management device (not shown in FIG. 1). The management device is connected to the central node device 120 through a communication network. In some embodiments, the communication network is a wired network or a wireless network.

In some embodiments, the wireless network or the wired network uses a standard communications technology and/or protocol. The network is usually the Internet, but may alternatively be any other networks, including but not limited to a local area network (LAN), a metropolitan area network (MAN), a wide area network (WAN), a mobile, wired, or wireless network, or any combination of a dedicated network or a virtual dedicated network). In some embodiments, technologies and/or formats, such as HyperText Markup Language (HTML) and extensible markup language (XML), are used for representing data exchanged through a network. In addition, all or some links may be encrypted by using conventional encryption technologies such as a secure socket layer (SSL), transport layer security (TLS), a virtual private network (VPN), and internet protocol security (IPsec). In other embodiments, custom and/or dedicated data communication technologies may also be used in place of or in addition to the foregoing data communication technologies.

FIG. 2 is a schematic structural diagram of a distributed system disposed based on a federated learning framework according to an exemplary embodiment. Referring to FIG. 2, the distributed system is composed of edge node devices 140 and a central node device 120. Each of the edge node devices 140 includes at least a terminal 141 and a data storage 142. The data storage 142 is configured to store data generated by the terminal 141, construct a training data set according to the data, and train at least one sub-model 143. The at least one sub-model 143 may be a preset learning model. The sub-model 143 may be trained according to the training data set stored in the data storage 142. During the training, random noise is added to at least one type of data based on a differential privacy mechanism during the training. Differential privacy (DP) is a system for publicly sharing information about a dataset by describing the patterns of groups within the dataset while withholding information about individuals in the dataset such that, if the effect of making an arbitrary single substitution in the database is small enough, the query result cannot be used to infer much about any single individual, and therefore provides privacy. The differential privacy mechanism can protect the privacy of the training data set. That is to say, a third-party device cannot obtain the specific training data in the training data set by inverse calculation of the model parameter of the sub-model trained and updated based on the differential privacy mechanism. The model training information corresponding to each trained sub-model is uploaded to the central node device 120. The central node device 120 includes at least a model ensemble operation module 121. The model training information is calculated according to an ensemble learning algorithm stored in the model ensemble operation module 121, to obtain a global model 122 generated after all trained sub-models are ensembled. The global model generated after the models are ensembled may be deployed in application scenarios as a trained machine learning model, or may be uploaded to a cloud database or a blockchain for downloading and use by other devices.

Federated learning is also referred to as federated machine learning, joint learning, or allied learning. Federated learning is a machine learning framework for a distributed system. A federated learning architecture includes a central node device and a plurality of edge node devices. Each edge node device stores training data locally, and the central node device and each edge node device. Models with a same model architecture are disposed in the central node device and each edge node device. Training machine learning models through the federated learning architecture is effective in resolving problems regarding isolated data islands. Then, participants are allowed to perform joint modelling without sharing data, technically eliminate isolated data islands, and realize AI collaboration.

Federated learning may include horizontal federated learning (HFL), vertical federated learning (VFL) and federated transfer learning (FTL). The solutions in this application are specifically applied in the HFL scenario.

In a scenario to which the HFL is applicable, data sets stored in all edge node devices participating in federated learning have a same feature space and different sample spaces. The HFL has an advantage of allowing an increase of samples, so that more data can be used.

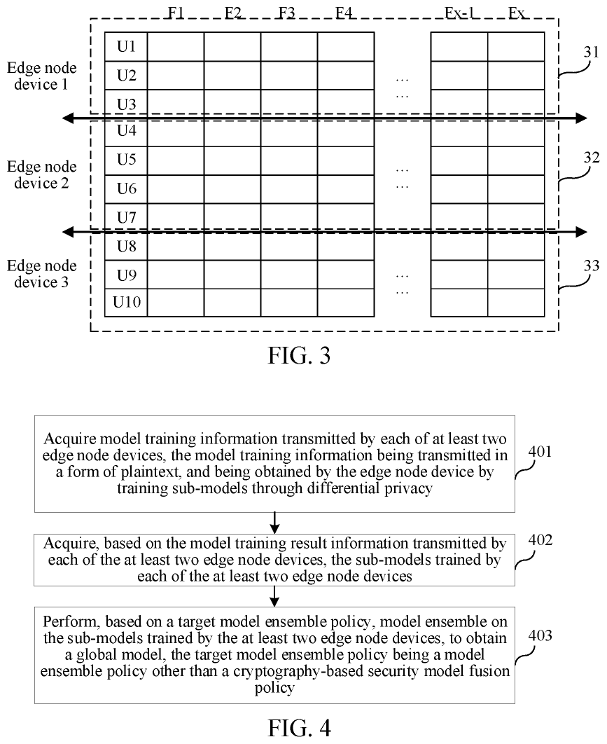

For example, FIG. 3 is a schematic diagram of HFL data distribution in this application. As shown in FIG. 3, the distributed system includes an edge node device 1, an edge node device 2, and an edge node device 3. A first data set 31 is stored in the edge node device 1. The first data set 31 includes samples U1 to U3 with feature data including F1 to Fx. A second data set 32 is stored in the edge node device 2. The second data set 32 includes samples U4 to U7 with feature data including F1 to Fx. A third data set 33 is stored in the edge node device 3. The third data set 33 includes samples U8 to U10 with feature data including F1 to Fx. Through the HFL, the overall federated learning data set can be expanded so that the overall federated learning data set includes the samples U1 to U10 with the feature data including F1 to Fx.

Through local training of the model based on the differential privacy mechanism on the edge node device, a third-party device cannot obtain the specific data in the data set by using an inverse calculation algorithm after acquiring the trained model. In this way, the privacy security is ensured.

In the differential privacy mechanism, two data sets D and D′ are assumed, and the two data sets D and D′ have only one piece of different. The two data sets may be referred to as adjacent data sets. A random algorithm A can act on two outputs obtained from the two adjacent data sets. For example, after two machine learning models are trained separately, if it is difficult to determine a data set from which each of the outputs is obtained, the random algorithm A is considered to satisfy the differential privacy requirement. Differential privacy is defined as follows:

∀WPr[WoutputonD]≤exp (ε)·Pr[WoutputonD′]+δ.

W is a machine learning model parameter; δ is used for indicating a positive number approximating 0, δ is inversely proportional to a number of elements in the set D or the set D′; and ε is used for indicating a privacy loss measure.

That is to say, machine learning models trained from any two adjacent data sets are probably similar. Therefore, small changes in the training data set cannot be detected by observing the parameter of the machine learning model, and the specific training data in the training data set cannot be deduced by observing the parameter of the machine learning model. In this way, the protection of data privacy can be realized.

FIG. 4 is a schematic flowchart of a data processing method according to an exemplary embodiment. The method is performed by a central node device in a distributed system. The central node device may be the above central node device 120 in the embodiment shown in FIG. 1. As shown in FIG. 4, the data processing method may include the following steps.

Step 401: Acquire model training information transmitted by each of the at least two edge node devices, the model training information being transmitted in a form of plaintext, and being obtained by the edge node device by training sub-models through differential privacy.

In this embodiment of this application, the central node device may receive the model training information transmitted by each of the at least two edge node devices.

The model training information is model data for indicating that a sub-model that has been trained. The model training information may be at least one of model gradient data, a model parameter, or a trained sub-model.

In one implementation, model structures of the sub-models trained by the at least two edge node devices are the same, partially the same, or different.

Step 402: Acquire, based on the model training information transmitted by each of the at least two edge node devices, the sub-models trained by the at least two edge node devices.

Step 403: Perform, based on a target model ensemble policy, model ensemble on the sub-models trained by the at least two edge node devices, to obtain a global model, the target model ensemble policy being a model ensemble policy other than a cryptography-based security model fusion policy.

In one implementation, the central node device performs model ensemble on the sub-models trained by the at least two edge node devices, to obtain at least one global model.

The central node device may perform model ensemble on the sub-models trained by the different at least two edge node devices, to generate different global models. For the same sub-models trained by the same at least two edge node devices, model ensemble may be performed according to different target model ensemble policies to generate different global models. The target model ensemble policies are model ensemble policies other than the cryptography-based security model fusion policy.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble effect.

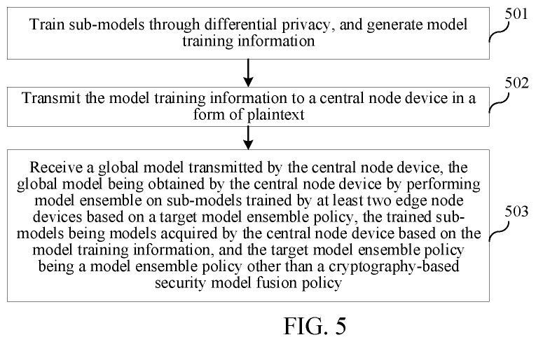

FIG. 5 is a schematic flowchart of a data processing method according to an exemplary embodiment. The method is performed by an edge node device in a distributed system. The edge node device may be the above edge node device 140 in the embodiment shown in FIG. 1. As shown in FIG. 5, the data processing method may include the following steps.

Step 501: Train sub-models through differential privacy, and generate model training information.

In one implementation, model structures of the sub-models trained by the at least two edge node devices are different.

Step 502: Transmit the model training information to the central node device in a form of plaintext.

Step 503: Receive a global model transmitted by the central node device, the global model being obtained by the central node device by performing model ensemble on the sub-models trained by the at least two edge node devices based on a target model ensemble policy, the trained sub-models being models acquired by the central node device based on the model training information, and the target model ensemble policy being a model ensemble policy other than a cryptography-based security model fusion policy.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble effect.

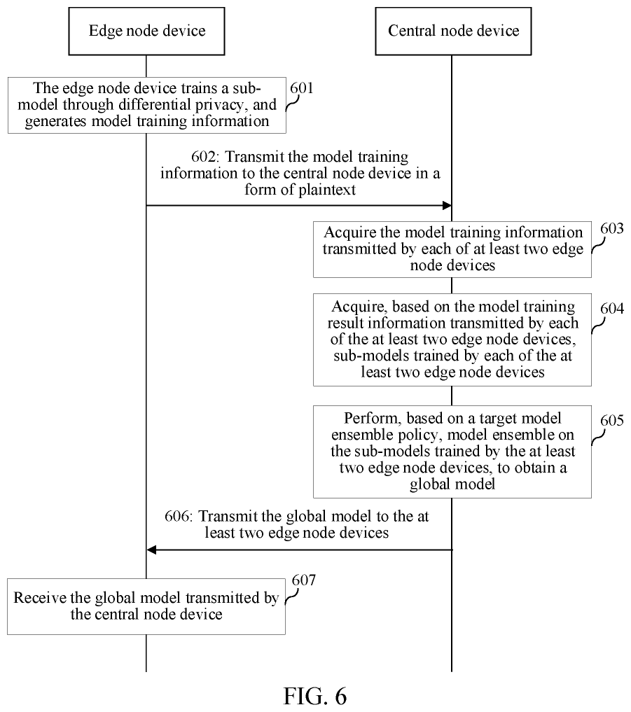

The central node device receives the model training information transmitted by the at least two edge node devices, generates the trained sub-models corresponding to the model training information, and performs model ensemble on the sub-models according to the target model policy in the central node device, to generate the global model. Since the generated global model is ensembled from the sub-models trained and updated by each edge node device, which means that the statistical characteristics of all samples possessed by each edge node device is acquired without leaking the private data of the samples, the global model can output more accurate results than each sub-model, and the global model is applicable to various fields such as image processing, financial analysis, and medical diagnosis. FIG. 6 is a flowchart of a data processing method according to an exemplary embodiment. The method may be jointly performed by a central node device and an edge node device in a distributed system. The distributed system may be a system disposed based on a federated learning framework. As shown in FIG. 6, the data processing method may include the following steps.

Step 601: The edge node device trains a sub-model through differential privacy, and generates model training information.

In this embodiment of this application, the edge node devices perform model training on respective sub-models through differential privacy, and can generate the model training information corresponding to each trained sub-model.

In one implementation, each sub-model trained by the edge node device through differential privacy is a neural network model or a mathematical model.

For example, the neural network model may include a deep neural network (DNN) model, a recurrent neural networks (RNN) model, an embedding model, and a gradient boosting decision tree (GBDT) model, and the like, and the mathematical model includes a linear model, a tree model, and the like, which are not enumerated in this embodiment.

At least two first training data sets stored in the at least two edge node devices conform to HFL data distribution. The first training data sets are data sets respectively stored locally by the at least two edge node devices and are used for training the sub-models.

In one implementation, the edge node device adds random noise to at least one of the first training data set, a model gradient, or a model parameter through differential privacy, and completes the training of each sub-model, and the central node device acquires the model training information corresponding to each trained sub-model.

The model training information may be a model parameter, a model gradient, or a complete model. When the model training information is the model parameter, each edge node device may train each sub-model through the first training data set to generate a model parameter. Each edge node device adds random noise to each generated model parameter through the differential privacy mechanism, and transmits each model parameter with the random noise added to the central node device. Alternatively, each edge node device may train each sub-model through the first training data set, to generate an intermediate model gradient, add random noise to each generated model gradient through the differential privacy mechanism, iteratively updates each sub-model based on each model gradient with the random noise, acquires a model parameter corresponding to each sub-model, and transmits each model parameter to the central node device. Alternatively, each edge node device may add random noise to the respective first training data set through the differential privacy mechanism, train each sub-model through the first training data set with the random noise, acquires a model parameter corresponding to each sub-model, and transmit each model parameter to the central node device.

When the model training information is the model gradient, each edge node device may train each sub-model through the first training data set, to generate an intermediate model gradient, add random noise to each generated model gradient through the differential privacy mechanism, iteratively updates each sub-model based on each model gradient with the random noise, acquires a model parameter corresponding to each sub-model, and transmits each model gradient with the random noise to the central node device. Alternatively, each edge node device adds random noise to the respective first training data set through the differential privacy mechanism, trains each sub-model through the first training data set with the random noise, to generate a model gradient, acquires a model parameter corresponding to each sub-model, and transmits each generated model gradient to the central node device.

When the model training information is the complete model, each trained sub-model is directly transmitted to the central node device in the form of plaintext.

In one implementation, a same differential privacy algorithm is used during training of the respective sub-models by the at least two edge node devices, or different differential privacy algorithms are used during the training of the respective sub-models by the at least two edge node devices.

The differential privacy algorithms may be a same differential privacy algorithm directly assigned by the central node device to each edge node device, or may be different differential privacy algorithms directly assigned by the central node device to each edge node device, or may be different differential privacy algorithms selected by the edge node devices based on respective sub-model structures.

Exemplarily, each edge node device may independently select a differential privacy mechanism, including differentially-private model training methods such as a differentially-private stochastic gradient descent (DP-SGD) algorithm, an algorithm based on private aggregation of teacher ensembles (PATE), and a differentially-private tree model. DP-SGD is a method that improves a stochastic gradient descent algorithm to realize differentially-private machine learning. PATE is a framework for training machine learning models through private data by combining a plurality of machine learning algorithms.

Step 602: The edge node device transmits the model training information to the central node device in a form of plaintext.

In this embodiment of this application, the edge node device transmits the model training information generated during the model training to the central node device in the form of plaintext.

In one implementation, the model training information corresponding to each trained sub-model in each edge node device is simultaneously transmitted to the central node device.

The model training information corresponding to trained sub-models in the same edge node device may be model training information of a same type, or may be model training information of different types.

For example, the edge node device 1 obtains a sub-model 1 and a sub-model 2 that have been trained through differentially-private model training. When the sub-model 1 is a linear model and the sub-model 2 is a deep neural network model, a complete model of the sub-model 1 and a model parameter corresponding to the sub-model 2 may be acquired as model training data, and are simultaneously transmitted to the central node device in the form of plaintext.

Step 603: The central node device acquires the model training information transmitted by each of the at least two edge node devices.

In this embodiment of this application, the central node device acquires the model training information corresponding to the at least one trained sub-model transmitted by each of the at least two edge node devices.

In one implementation, the model training information is transmitted in the form of plaintext, and is obtained by the edge node device by training the sub-models through differential privacy. The model structures of the sub-models trained by the at least two edge node devices are different.

In one implementation, numbers and model structures of the sub-models trained by the edge node devices are different.

The model structures corresponding to the sub-models trained by the edge node devices being different may mean that the model structures of some sub-models are different.

For example, the first training data set in the edge node device 1 is a data set 1, and a sub-model A and a sub-model B may be trained through the data set 1. The first training data set in the edge node device 2 is a data set 2, and a sub-model C, a sub-model D, and a sub-model E may be trained through the data set 2. The sub-model A and the sub-model B may be respectively a linear model and a tree model, and the sub-model C, the sub-model D, and the sub-model E may be respectively a linear model, a deep neural network model, and a recurrent neural network model. Model structures of the sub-model A and the sub-model C are the same, and model structures of the remaining sub-models are different.

Step 604: The central node device acquires, based on the model training information transmitted by each of the at least two edge node devices, the sub-models trained by each of the at least two edge node devices.

In this embodiment of this application, the central node device acquires, based on the model training information transmitted by each of the at least two edge node devices, the complete sub-models trained by the at least two edge node devices.

In one implementation, when the model training information is the model gradient, the central node device acquires a model gradient corresponding to each trained sub-model, and iteratively updates each sub-model through the acquired model gradient according to the model structure corresponding to each sub-model, to generate the each corresponding trained sub-model. When the model training information is the model parameter, the central node device acquires a model parameter corresponding to each trained sub-model, and updates each sub-model according to the model structure corresponding to each sub-model, to generate the each corresponding trained sub-model.

Step 605: Perform, based on a target model ensemble policy, model ensemble on the sub-models trained by the at least two edge node devices, to obtain a global model.

In this embodiment of this application, the central node device performs, based on the target model ensemble policy, model ensemble on the sub-models trained by the at least two edge node devices, to obtain at least one global model.

The target model ensemble policy is a model ensemble policy other than a cryptography-based security model fusion policy.

The cryptography-based security model fusion policy is a policy of model fusion through a federated average algorithm. Other model ensemble policies may include at least one of a federated bagging and ensemble policy, a stacking, ensemble, and fusion policy, a knowledge distillation and ensemble policy, a voting, ensemble, and fusion policy, or a model grafting policy.

In response to the target model ensemble policy including a first model ensemble policy and the first model ensemble policy being the federated bagging and ensemble policy, the above model ensemble process may be as follows:

The central node device acquires ensemble weights corresponding to the sub-models trained by the at least two edge node devices; acquires at least one sub-model from the sub-models trained by the at least two edge node devices, to generate at least one ensemble model set; and performs weighted average on the sub-models in the at least one ensemble model set based on the ensemble weights, to obtain at least one global model.

The ensemble weights are used for indicating impact of output values of the sub-models on an output value of the global model. The ensemble model set is a set of sub-models for ensembling into a global model.

In one implementation, the ensemble weights of the sub-models trained by the at least two edge node devices are acquired based on a weight impact parameter of each of the at least two edge node devices.

The weight impact parameter includes at least one of reliability corresponding to the edge node device or a data amount of the first training data set in the edge node device.

In one implementation, the ensemble weights are positively correlated with the impact data.

For example, the edge node device 1 belongs to a company A and the edge node device 2 belongs to a company B. When a data amount of the first training data set of the company A is greater than a data amount of the first training data set of the company B, the ensemble weight corresponding to the sub-model trained by the edge node device 1 is greater than the ensemble weight corresponding to the sub-model trained by the edge node device 2. When reliability of the central node device to the company A is greater than reliability of the central node device to the company B, the ensemble weight corresponding to the sub-model trained by the edge node device 1 is greater than the ensemble weight corresponding to the sub-model trained by the edge node device 2.

Exemplarily, a federated server in the central node device may perform bagging, ensembling, and fusion on the received sub-model trained by the edge node device. When the global model is a federated bagging model, an output of the federated bagging model may be a weighted average of the outputs of the sub-models, which is as follows:

$$y = \frac{1}{{\sum }_{k = 0}^{K - 1} {θ}_{k}} ( {\sum }_{k = 0}^{K - 1} {θ}_{k} {y}_{k} ) .$$

y is the output of the federated bagging model; yₖ is an output of a sub-model of an edge node device k; and θₖ is an ensemble weight of the edge node device k.

In one implementation, when the sub-model is a classification model, a weighted average is performed on classification results of the sub-models generated by the edge node device, or weighted average is performed on the outputs of the sub-models corresponding to the edge node device, that is, the outputs before the classification result is obtained.

For example, the weighted average of the outputs before the classification result may be weighted average of outputs of a sigmoid function or a softmax function.

In response to the target model ensemble policy including a second model ensemble policy and the second model ensemble policy being the stacking, ensembling, and fusion policy (Federated Stacking), the above model ensemble process may be as follows:

In response to the central node device including a second training data set, the second training data set being a data set stored in the central node device, and the second training data set including feature data and label data, the central node device acquires a first initial global model, inputs the feature data in the second training data set to the sub-models trained by the at least two edge node devices, to obtain at least two pieces of first output data, inputs the first output data to the first initial global model, and updates a model parameter in the first initial global model based on the label data in the second training data set and an output result of the first initial global model, to obtain the global model.

The first initial global model may be a linear model, a tree model, a neural network model, or the like.

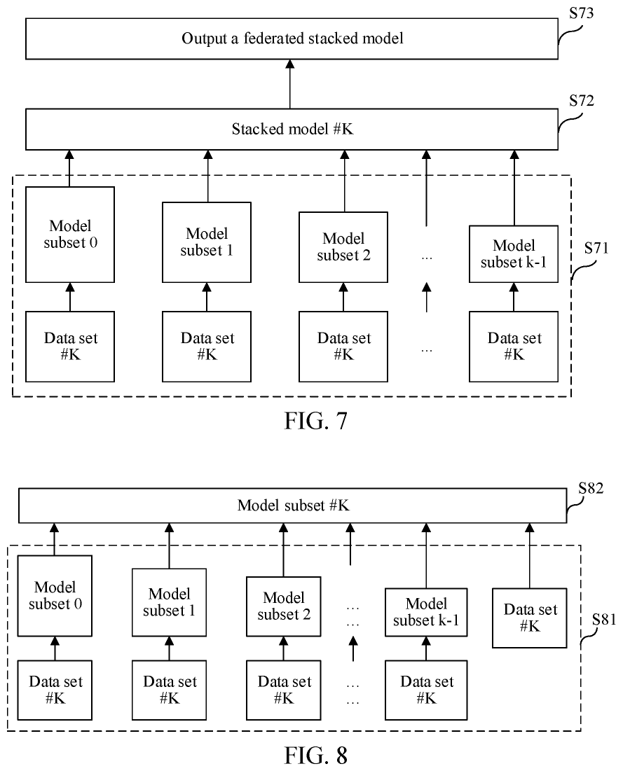

Exemplarily, FIG. 7 is a schematic diagram of federated stacking and ensemble learning according to an embodiment of this application. As shown in FIG. 7, in the central node device, the acquired sub-models of each edge node device may form a model subset. Sub-models corresponding to the edge node device 0 may form a model subset 0, sub-models corresponding to the edge node device 1 may form a model subset 1, sub-models corresponding to the edge node device 2 may form a model subset 2, and sub-models corresponding to an edge node device k-1 may form a model subset k-1. A second training data set #K stored in the central node device is input to each model subset, to obtain an output corresponding to each sub-model in each model subset (S71). The output corresponding to each sub-model in each model subset is input into the first initial global model, that is, a stacking model #K (S72). Model training is performed on the stacking model #K to generate a global model, that is, a federated stacking model (S73). Taking the linear model as an example, the federated stacking model is shown as follows:

$$y = {\sum }_{k = 0}^{K - 1} {w}_{k} {y}_{k} + b .$$

wₖ is a model parameter that a federated server corresponding to the central node device needs to learn, and b is a bias term that the federated server corresponding to the central node device needs to learn.

In response to the target model ensemble policy including a third model ensemble policy and the third model ensemble policy being the knowledge distillation and ensemble policy, the above model ensemble process may be as follows:

The central node device includes a second training data set, the second training data set is a data set stored in the central node device, and the second training data set includes feature data and label data. The central node device acquires a second initial global model, inputs the feature data in the second training data set to the sub-models trained by the at least two edge node devices, to obtain at least two pieces of first output data, inputs the first output data and the feature data in the second training data set to the second initial global model to obtain second output data, and updates a model parameter in the second initial global model based on the second output data and the label data in the second training data set as sample data, to obtain the global model.

Exemplarily, FIG. 8 is a schematic diagram of federated knowledge distillation learning according to an embodiment of this application. As shown in FIG. 8, in the central node device, the acquired sub-models corresponding to each edge node device may form a model subset. Sub-models corresponding to the edge node device 0 may form a model subset 0, sub-models corresponding to the edge node device 1 may form a model subset 1, sub-models corresponding to the edge node device 2 may form a model subset 2, and sub-models corresponding to an edge node device k-1 may form a model subset k-1. A second training data set #K stored in the central node device is input to each model subset, to obtain an output corresponding to each sub-model in each model subset. The output corresponding to each sub-model and the second training data set are input to the model subset #K composed of the at least one second initial global model (S81). At least one global model is generated (S82).

In response to the target model ensemble policy including a fourth model ensemble policy and the fourth model ensemble policy being a voting, ensembling, and fusion policy (federated voting), the above model ensemble process may be as follows:

The central node device includes a second training data set, the second training data set is a data set stored in the central node device, and the second training data set includes feature data and label data. The central node device acquires at least one third initial global model, the third initial global model being a classification model, inputs the feature data in the second training data set to the sub-models trained by the at least two edge node devices, to obtain at least two pieces of first output data, collects statistics on classification results of the first output data in response to the first output data being classification result data, to obtain a statistical result corresponding to each of the classification results, and updates a model parameter in the third initial global model based on the statistical result and the label data, to obtain the global model.

Exemplarily, for a binary classification model, an output result of the model is a positive class or a negative class. The global model may be a federated voting model, and a classification result of the federated voting model depends on “majority voting” of the classification results of the sub-models corresponding to the edge node device. For to-be-classified data, if the classification results of majority sub-models corresponding to the edge node device are the “positive class”, the classification result of the federated voting model is the “positive class”. On the contrary, if the classification results of majority sub-models corresponding to the edge node device are the “negative class”, the classification result of the federated voting model is the “negative class”. When numbers of the two classification results are the same, the classification result of the federated voting model may be determined simply by random selection, and the federated voting model may be updated according to the classification result to generate an updated global model.

In response to the target model ensemble policy including a fifth model ensemble policy and the fifth model ensemble policy being the model grafting method, the above model ensemble process may be as follows:

The central node device acquires a functional layer of at least one sub-model from the sub-models corresponding to the edge node devices, the functional layer being configured to indicate a partial model structure that implements a specified functional operation; and acquires a model including at least two functional layers as the global model in response to the model composed of the at least two functional layers having a complete model structure.

Exemplarily, the federated server corresponding to the central node device perform model ensemble on the received sub-models of the edge node devices through model grafting. When the sub-model is a neural network model, different layers may be extracted from the sub-models of different edge node devices and then recombined to generate a global model.

In one implementation, when the central node device has the second training data set, model training is performed on the combined model to generate a global model.

For example, the edge node device 1 obtains the trained sub-model 1 through differentially-private model training. When the sub-model 1 is a convolutional neural network model, the edge node device 2 obtains the trained sub-model 2 through differentially-private model training, and the sub-model 2 is a recurrent neural network model. The central node device may perform model grafting on an input layer and a convolution layer of the sub-model 1 and a fully connected layer and an output layer of the sub-model 2 to generate a global model.

Step 606: The central node device transmits the global model to the at least two edge node devices.

In this embodiment of this application, the central node device may transmit the generated at least one global model to each edge node device.

In one implementation, the central node device uploads the at least one global model to a federated learning platform on a public cloud or a private cloud to provide federated learning services to the public.

Step 607: The edge node device receives the global model transmitted by the central node device.

In one implementation, the edge node device receives the model parameter corresponding to the global model transmitted by the central node device, and the edge node device generates the corresponding global model according to the received model parameter and the model structure corresponding to the global model.

The global model is obtained by the central node device by performing model ensemble on the sub-models trained by the at least two edge node devices based on the target model ensemble policy, and the trained sub-models are models acquired by the central node device based on the model training information.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble effect.

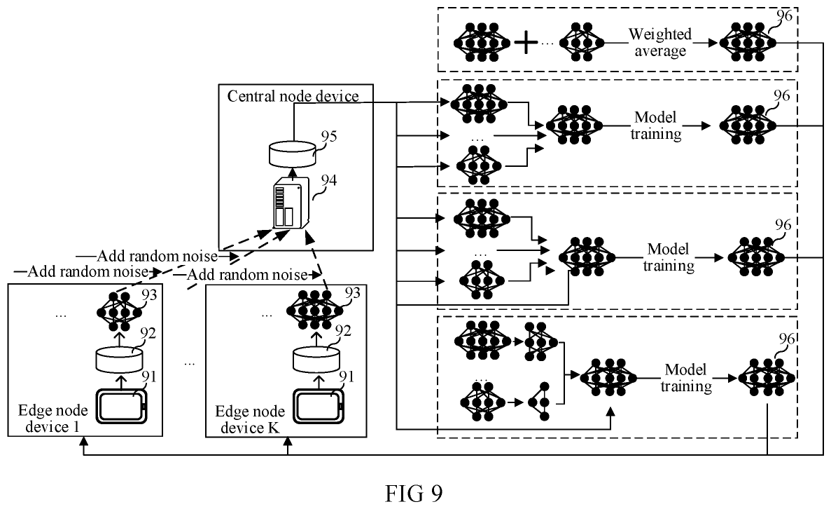

FIG. 9 is a schematic framework diagram of a data processing method based on a distributed system according to an exemplary embodiment. As shown in FIG. 9, the distributed system includes k edge node devices. Each edge node device includes a terminal 91 and a data storage 92. The data storage 92 stores a first training data set. Each edge node device trains each sub-model through a differential privacy mechanism, to generate each trained sub-model 93. Each edge node device transmits each trained sub-model 93 to the central node device. A model ensemble operation module 94 in the central node device performs model ensemble on the sub-models. The sub-models may generate a global model 96 through weighted average of the sub-models. Alternatively, a second training data set is acquired from the data storage 95 of the central node device, the second training data set is input to each trained sub-model 93 to obtain a model output, and model training is performed on the global model according to each model output, so that the central node device generates a trained global model 96. Alternatively, the central node device inputs the second training data set to each trained sub-model 93 to obtain the model output, and trains the global model according to the model output and the second training data set to generate the trained global model 96. Alternatively, the central node device acquires the functional layer in each sub-model, performs model grafting on the functional layers to generate a global model, and then performs model training on the global model based on the second training data set, to obtain the trained global model 96. The ensembled global model 96 may be transmitted to each edge node device for model application by each edge node device.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble effect.

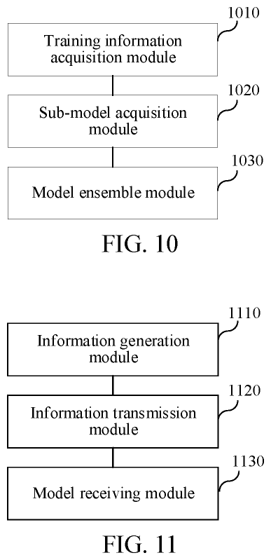

FIG. 10 is a structural block diagram of a data processing apparatus according to an exemplary embodiment. The data processing apparatus is applicable to a central node device in a distributed system, and can implement all or part of the steps in the method provided in the embodiment shown in FIG. 4 or FIG. 6. The data processing apparatus includes:

a training information acquisition module 1010, configured to acquire model training information transmitted by each of the at least two edge node devices, the model training information being transmitted in a form of plaintext, and being obtained by the edge node device by training sub-models through differential privacy;

a sub-model acquisition module 1020, configured to acquire, based on the model training information transmitted by each of the at least two edge node devices, the sub-models trained by each of the at least two edge node devices; and

a model ensemble module 1030, configured to perform, based on a target model ensemble policy, model ensemble on the sub-models trained by the at least two edge node devices, to obtain a global model, the target model ensemble policy being a model ensemble policy other than a cryptography-based security model fusion policy.

In one implementation, in response to the target model ensemble policy including a first model ensemble policy,

the model ensemble module 1030 includes:

a weight acquisition submodule, configured to acquire ensemble weights of the sub-models trained by the at least two edge node devices, the ensemble weights being used for indicating impact of output values of the sub-models on an output value of the global model;

a model set generation submodule, configured to acquire at least one sub-model from the sub-models trained by the at least two edge node devices, to generate at least one ensemble model set, the ensemble model set being a set of sub-models for ensembling into a global model; and

a first model acquisition submodule, configured to perform weighted averaging on the sub-models in the at least one ensemble model set based on the ensemble weights to obtain the at least one global model.

In one implementation, the weight acquisition submodule includes

a weight acquisition unit, configured to acquire, based on a weight impact parameter of each of the at least two edge node devices, the ensemble weights of the sub-models trained by the at least two edge node devices,

the weight impact parameter including at least one of reliability of the edge node device or a data amount of a first training data set in the edge node device.

In one implementation, in response to the target model ensemble policy including a second model ensemble policy, the central node device includes a second training data set, the second training data set being a data set stored in the central node device, and including feature data and label data; and

the model ensemble module 1030 includes:

a first initial model acquisition submodule, configured to acquire a first initial global model based on the second model ensemble policy;

a first output acquisition submodule, configured to input the feature data in the second training data set to the sub-models trained by the at least two edge node devices, to obtain at least two pieces of first output data;

a first model parameter update submodule, configured to input the first output data to the first initial global model; and

a second model acquisition submodule, configured to update a model parameter in the first initial global model based on the label data in the second training data set and an output result of the first initial global model, to obtain the global model.

In one implementation, in response to the target model ensemble policy including a third model ensemble policy, the central node device includes a second training data set, the second training data set being a data set stored in the central node device, and including feature data and label data; and

the model ensemble module 1030 includes:

a second initial model acquisition submodule, configured to acquire a second initial global model based on the third model ensemble policy;

a first output acquisition submodule, configured to input the feature data in the second training data set to the sub-models trained by the at least two edge node devices, to obtain at least two pieces of first output data;

a second output acquisition submodule, configured to input the first output data and the feature data in the second training data set to the second initial global model to obtain second output data; and

a second model parameter update submodule, configured to update a model parameter in the second initial global model based on the second output data and the label data in the second training data set, to obtain the global model.

In one implementation, in response to the target model ensemble policy including a fourth model ensemble policy, the central node device includes a second training data set, the second training data set being a data set stored in the central node device, and including feature data and label data; and

the model ensemble module 1030 includes:

a third initial model acquisition submodule, configured to acquire a third initial global model based on the fourth model ensemble policy, the third initial global model being a classification model;

a first output acquisition submodule, configured to input the feature data in the second training data set to the sub-models trained by the at least two edge node devices, to obtain at least two pieces of first output data;

a result acquisition submodule, configured to collect statistics on classification results of the first output data in response to the first output data being classification result data, to obtain a statistical result corresponding to each of the classification results; and

a third model parameter updating submodule, configured to update a model parameter in the third initial global model based on the statistical result and the label data, to obtain the global model.

In one implementation, in response to the target model ensemble policy including a fifth model ensemble policy,

the model ensemble module 1030 includes:

a functional layer acquisition submodule, configured to acquire a functional layer of at least one sub-model from the sub-models corresponding to the edge node devices based on the fifth model ensemble policy, the functional layer being configured to indicate a partial model structure that implements a specified functional operation; and

a fifth model parameter acquisition submodule, configured to acquire a model including at least two functional layers as the global model in response to the model composed of the at least two functional layers having a complete model structure.

In one implementation, a same differential privacy algorithm is used during the training performed by the at least two edge node devices on the respective sub-models;

or

different differential privacy algorithms are used during the training performed by the at least two edge node devices on the respective sub-models.

In one implementation, the at least two first training data sets stored in the at least two edge node devices conform to horizontal federated learning (HFL) data distribution.

In one implementation, model structures of the sub-models trained by the at least two edge node devices are different.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data privacy security is ensured, thereby improving the model ensemble effect.

FIG. 11 is a structural block diagram of a data processing apparatus according to an exemplary embodiment. The data processing apparatus is applicable to edge node devices in a distributed system. The distributed system includes a central node device and the at least two edge node devices, and can implement all or part of the steps in the method provided in the embodiment shown in FIG. 5 or FIG. 6. The data processing apparatus includes:

an information generation module 1110, configured to train sub-models through differential privacy, and generate model training information;

an information transmission module 1120, configured to transmit the model training information to the central node device in a form of plaintext; and

a model receiving module 1130, configured to receive a global model transmitted by the central node device, the global model being obtained by the central node device by performing model ensemble on the sub-models trained by the at least two edge node devices based on a target model ensemble policy, the trained sub-models being models acquired by the central node device based on the model training information, and the target model ensemble policy being a model ensemble policy other than a cryptography-based security model fusion policy.

In conclusion, in the solution shown in this embodiment of this application, in the distributed system, each of the at least two edge node devices trains the sub-models through differential privacy, and then transmits the model training information obtained by training the sub-models to the central node device in the form of plaintext, and the central node device acquires, through the received model training information, the sub-models trained by the edge node devices, and performs model ensemble on the trained sub-models by using a model ensemble policy other than the cryptography-based security model fusion policy, to generate the global model. In the above solution, since the differential privacy mechanism is used, the central node device can directly acquire the model training information of the plurality of sub-models in the form of plaintext. Therefore, the model ensemble process is not restricted by the cryptography-based security model fusion policy, thereby resolving the problem that the federated average algorithm is required to be used for model ensemble in traditional HFL. In this way, the manner of model ensemble is expanded while data security is ensured, thereby improving the model ensemble quality.

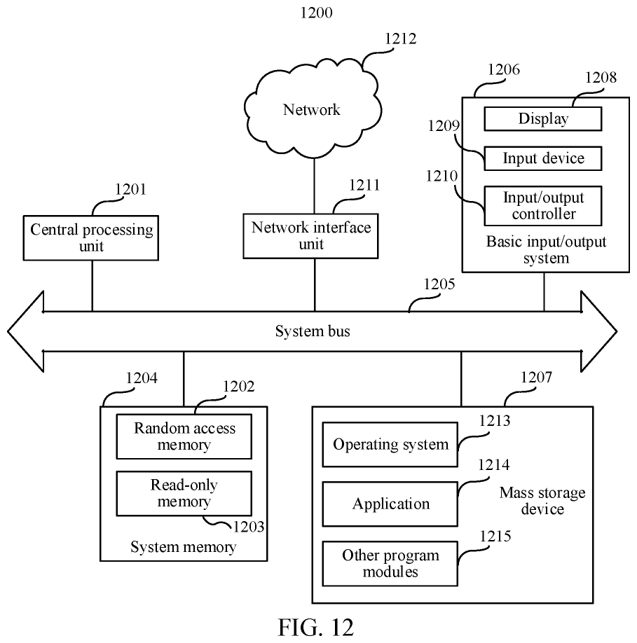

FIG. 12 is a schematic structural diagram of a computer device according to an exemplary embodiment. The computer device may be implemented as the distributed system in each of the above method embodiments. The computer device 1200 includes a central processing unit (CPU) 1201, a system memory 1204 including a random access memory (RAM) 1202 and a read-only memory (ROM) 1203, and a system bus 1205 connecting the system memory 1204 to the CPU 1201. The computer device 1200 further includes a basic input/output (I/O) system 1206 assisting in transmitting information between components in a computer, and a mass storage device 1207 configured to store an operating system 1213, an application program 1214, and another program module 1215.

The mass storage device 1207 is connected to the CPU 1201 by using a mass storage controller (not shown) connected to the system bus 1205. The mass storage device 1207 and an associated computer-readable medium provide non-volatile storage for the computer device 1200. That is, the mass storage device 1207 may include a computer-readable medium (not shown) such as a hard disk or a compact disc read only memory (CD-ROM) drive.

In general, the computer-readable medium may include a computer storage medium and a communication medium. The computer storage medium includes volatile and non-volatile, removable and non-removable media that are configured to store information such as computer-readable instructions, data structures, program modules, or other data and that are implemented by using any method or technology. The computer storage medium includes a RAM, a ROM, a flash memory or another solid-state memory technology, a CD-ROM, or another optical memory, a magnetic cassette, a magnetic tape, a magnetic disk memory, or another magnetic storage device. Certainly, a person skilled in the art may learn that the computer storage medium is not limited to the above. The foregoing system memory 1204 and mass storage device 1207 may be collectively referred to as a memory.

The computer device 1200 may be connected to the Internet or another network device by using a network interface unit 1211 connected to the system bus 1205.

The memory further includes one or more programs. The one or more programs are stored in the memory. The CPU 1201 executes the one or more programs to implement all or some steps of the method shown in FIG. 4, FIG. 5, or FIG. 6.

In an exemplary embodiment, a non-temporary computer-readable storage medium including an instruction, for example, a memory including a computer program (an instruction), is further provided, and the program (the instruction) may be executed by a processor in a computer device to complete the method shown in the embodiments of this application. For example, the non-transitory computer readable storage medium may be a read-only memory (Read-Only Memory, ROM), a random access memory (Random Access Memory, RAM), a compact disc read-only memory (Compact Disc Read-Only Memory, CD-ROM, a tape, a floppy disk, an optical data storage device, or the like.

In an exemplary embodiment, a computer program product or a computer program is further provided, including computer instructions, the computer instructions being stored in a computer-readable storage medium. A processor of a computer device reads the computer instructions from the computer-readable storage medium, and executes the computer instructions, to cause the computer device to perform the method shown in the foregoing embodiments.

Other embodiments of this application will be apparent to a person skilled in the art from consideration of the specification and practice of the disclosure here. This application is intended to cover any variation, use, or adaptive change of this application. These variations, uses, or adaptive changes follow the general principles of this application and include common general knowledge or common technical means in the art that are not disclosed in this application. The specification and the embodiments are considered as merely exemplary, and the real scope and spirit of this application are pointed out in the claims.

It is to be understood that this application is not limited to the precise structures described above and shown in the accompanying drawings, and various modifications and changes can be made without departing from the scope of this application. The scope of this application is limited by the appended claims only. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A data processing method, performed by a central node device in a distributed system, comprising:
acquiring model training information transmitted by each of at least two edge node devices of the distributed system, the model training information being transmitted in a form of plaintext, and being obtained by the edge node device by training sub-models through differential privacy;
acquiring, based on the model training information transmitted by each of the at least two edge node devices, the sub-models trained by each of the at least two edge node devices; and
performing, based on a target model ensemble policy, model ensemble on the sub-models trained by the at least two edge node devices, to obtain a global model, the target model ensemble policy being a model ensemble policy other than a cryptography-based security model fusion policy.

2. The method according to claim 1, wherein the target model ensemble policy comprises a first model ensemble policy,
the performing, based on a target model ensemble policy, model ensemble on the sub-models trained by the at least two edge node devices, to obtain a global model comprises:
acquiring, based on the first model ensemble policy, ensemble weights of the sub-models trained by the at least two edge node devices, the ensemble weights being used for indicating impact of output values of the sub-models on an output value of the global model;
acquiring at least one sub-model from the sub-models trained by the at least two edge node devices, to generate at least one ensemble model set, the ensemble model set being a set of sub-models for ensembling into a global model; and
performing weighted averaging on the sub-models in the at least one ensemble model set based on the ensemble weights to obtain the at least one global model.

3. The method according to claim 1, wherein the target model ensemble policy comprises a second model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a first initial global model based on the second model ensemble policy;
inputting the feature data in the second training data set to the sub-models trained by the at least two edge node devices, to obtain at least two pieces of first output data;
inputting the first output data to the first initial global model; and
updating a model parameter in the first initial global model based on the label data in the second training data set and an output result of the first initial global model, to obtain the global model.

4. The method according to claim 1, wherein the target model ensemble policy comprises a third model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a second initial global model based on the third model ensemble policy;
inputting the feature data in the second training data set to the sub-models trained by the at least two edge node devices, to obtain at least two pieces of first output data;
inputting the first output data and the feature data in the second training data set to the second initial global model to obtain second output data; and
updating a model parameter in the second initial global model based on the second output data and the label data in the second training data set, to obtain the global model.

5. The method according to claim 1, wherein the target model ensemble policy comprises a fourth model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a third initial global model based on the fourth model ensemble policy, the third initial global model being a classification model;
inputting the feature data in the second training data set to the sub-models trained by the at least two edge node devices, to obtain at least two pieces of first output data;
collecting statistics on classification results of the first output data in response to the first output data being classification result data, to obtain a statistical result corresponding to each of the classification results; and
updating a model parameter in the third initial global model based on the statistical result and the label data, to obtain the global model.

6. The method according to claim 1, wherein the target model ensemble policy comprises a fifth model ensemble policy,
the performing, based on a target model ensemble policy, model ensemble on the sub-models trained by the at least two edge node devices, to obtain a global model comprises:
acquiring a functional layer of at least one sub-model from the sub-models corresponding to the edge node devices based on the fifth model ensemble policy, the functional layer being configured to indicate a partial model structure that implements a specified functional operation; and
acquiring a model comprising at least two functional layers as the global model in response to the model composed of the at least two functional layers having a complete model structure.

7. The method according to claim 1, wherein a same differential privacy algorithm is used during the training performed by the at least two edge node devices on the respective sub-models; or different differential privacy algorithms are used during the training performed by the at least two edge node devices on the respective sub-models.

8. The method according to claim 1, wherein the at least two first training data sets stored in the at least two edge node devices conform to horizontal federated learning (HFL) data distribution.

9. The method according to claim 1, wherein the model structures of the sub-models trained by the at least two edge node devices are different.

10. A computer device acting as a central node device in a distributed system, comprising a processor and a memory, the memory storing at least one instruction, the at least one instruction, being loaded and executed by the processor and causing the computer device to implement a data processing method including:
acquiring model training information transmitted by each of at least two edge node devices of the distributed system, the model training information being transmitted in a form of plaintext, and being obtained by the edge node device by training sub-models through differential privacy;
acquiring, based on the model training information transmitted by each of the at least two edge node devices, the sub-models trained by each of the at least two edge node devices; and
performing, based on a target model ensemble policy, model ensemble on the sub-models trained by the at least two edge node devices, to obtain a global model, the target model ensemble policy being a model ensemble policy other than a cryptography-based security model fusion policy.

11. The computer device according to claim 10, wherein the target model ensemble policy comprises a first model ensemble policy,
the performing, based on a target model ensemble policy, model ensemble on the sub-models trained by the at least two edge node devices, to obtain a global model comprises:
acquiring, based on the first model ensemble policy, ensemble weights of the sub-models trained by the at least two edge node devices, the ensemble weights being used for indicating impact of output values of the sub-models on an output value of the global model;
acquiring at least one sub-model from the sub-models trained by the at least two edge node devices, to generate at least one ensemble model set, the ensemble model set being a set of sub-models for ensembling into a global model; and
performing weighted averaging on the sub-models in the at least one ensemble model set based on the ensemble weights to obtain the at least one global model.

12. The computer device according to claim 10, wherein the target model ensemble policy comprises a second model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a first initial global model based on the second model ensemble policy;
inputting the feature data in the second training data set to the sub-models trained by the at least two edge node devices, to obtain at least two pieces of first output data;
inputting the first output data to the first initial global model; and
updating a model parameter in the first initial global model based on the label data in the second training data set and an output result of the first initial global model, to obtain the global model.

13. The computer device according to claim 10, wherein the target model ensemble policy comprises a third model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a second initial global model based on the third model ensemble policy;
inputting the feature data in the second training data set to the sub-models trained by the at least two edge node devices, to obtain at least two pieces of first output data;
inputting the first output data and the feature data in the second training data set to the second initial global model to obtain second output data; and
updating a model parameter in the second initial global model based on the second output data and the label data in the second training data set, to obtain the global model.

14. The computer device according to claim 10, wherein the target model ensemble policy comprises a fourth model ensemble policy, the central node device comprises a second training data set, the second training data set being a data set stored in the central node device, and comprising feature data and label data; and
the performing, based on a target model ensemble policy, model ensemble on the sub-models trained by the at least two edge node devices, to obtain a global model comprises:
acquiring a third initial global model based on the fourth model ensemble policy, the third initial global model being a classification model;
inputting the feature data in the second training data set to the sub-models trained by the at least two edge node devices, to obtain at least two pieces of first output data;
collecting statistics on classification results of the first output data in response to the first output data being classification result data, to obtain a statistical result corresponding to each of the classification results; and
updating a model parameter in the third initial global model based on the statistical result and the label data, to obtain the global model.

15. The computer device according to claim 10, wherein the target model ensemble policy comprises a fifth model ensemble policy,
the performing, based on a target model ensemble policy, model ensemble on the sub-models trained by the at least two edge node devices, to obtain a global model comprises:
acquiring a functional layer of at least one sub-model from the sub-models corresponding to the edge node devices based on the fifth model ensemble policy, the functional layer being configured to indicate a partial model structure that implements a specified functional operation; and
acquiring a model comprising at least two functional layers as the global model in response to the model composed of the at least two functional layers having a complete model structure.

16. The computer device according to claim 10, wherein a same differential privacy algorithm is used during the training performed by the at least two edge node devices on the respective sub-models; or different differential privacy algorithms are used during the training performed by the at least two edge node devices on the respective sub-models.

17. The computer device according to claim 10, wherein the at least two first training data sets stored in the at least two edge node devices conform to horizontal federated learning (HFL) data distribution.

18. The computer device according to claim 10, wherein the model structures of the sub-models trained by the at least two edge node devices are different.

19. A non-transitory computer-readable storage medium, storing at least one instruction, the at least one instruction being loaded and executed by a processor of a computer device acting as a central node device in a distributed system and causing the computer device to implement a data processing method including:
acquiring model training information transmitted by each of at least two edge node devices of the distributed system, the model training information being transmitted in a form of plaintext, and being obtained by the edge node device by training sub-models through differential privacy;
acquiring, based on the model training information transmitted by each of the at least two edge node devices, the sub-models trained by each of the at least two edge node devices; and
performing, based on a target model ensemble policy, model ensemble on the sub-models trained by the at least two edge node devices, to obtain a global model, the target model ensemble policy being a model ensemble policy other than a cryptography-based security model fusion policy.

20. The non-transitory computer-readable storage medium according to claim 19, wherein the at least two first training data sets stored in the at least two edge node devices conform to horizontal federated learning (HFL) data distribution.
